(19) United States
(12) Patent Application Publication
(10) Pub. No.: US 2026/0221859 A1
(43) Pub. Date: Jul. 30, 2026

(54) SWITCHING CONVERTER WITH IMPROVED TRANSIENT RESPONSE

(71) Applicant: Chengdu Monolithic Power Systems Co., Ltd., Chengdu (CN)

(72) Inventors: Mingliang Liu, Chengdu (CN); Shufa Jiang, Chengdu (CN)

(21) Appl. No.: 19/438,293

(22) Filed: Dec. 31, 2025

(30) Foreign Application Priority Data
Jan. 24, 2025 (CN) 202510117155.1

(51) Int. Cl. H02M 1/00; H02M 1/08; H02M 3/158

(52) U.S. Cl. CPC H02M 1/0022; H02M 1/0009; H02M 1/08; H02M 3/158

(57) ABSTRACT

A control circuit for a switching converter. The control circuit includes a compensation current generator, a peak voltage generator and a comparison circuit. The compensation current generator is configured to generate a compensation current signal based on an output voltage feedback signal indicative of the output voltage and an output voltage reference signal. The peak voltage generator is configured to generate a peak voltage signal based on the compensation current signal and a current sensing signal indicative of a current flowing through a power switch of the switching converter. The comparison circuit is configured to generate a turning off control signal to control the turning off of the power switch by comparing the peak voltage signal with a reference signal.

### CROSS-REFERENCE TO RELATED APPLICATIONS

This application claims the benefit of CN application 202510117155.1, filed on January 24, 2025, and incorporated herein by reference.

### TECHNICAL FIELD OF THE INVENTION

The present invention generally relates to electronic circuits, and more particularly but not exclusively, to switching converters.

### BACKGROUND OF THE INVENTION

In recent years, many electronic devices have adopted OLED (Organic Light-Emitting Diode). An OLED driver (e.g., a switching power supply) generates an output voltage to drive panels based on an input voltage. When the ambient brightness around an electronic device changes, the panel brightness also changes accordingly. For example, when a mobile phone is moved from indoors to outdoors, the screen usually becomes brighter. At this time, the load of the OLED driver changes rapidly. In order to avoid panel flicker, the output voltage is required to remain stable during load transients. Therefore, it is required to propose a switching power supply with excellent transient response to a change of the load, capable of maintaining stable output voltage during load transients.

### SUMMARY OF THE INVENTION

An embodiment of the present invention discloses a control circuit for a switching converter converting an input voltage to an output voltage. The control circuit includes a compensation current generator, a peak voltage generator and a comparison circuit. The compensation current generator is configured to generate a compensation current signal based on an output voltage feedback signal indicative of the output voltage and an output voltage reference signal. The peak voltage generator is configured to generate a peak voltage signal based on the compensation current signal and a current sensing signal indicative of a current flowing through a power switch of the switching converter. The comparison circuit is configured to generate a turning off control signal to control the turning off of the power switch by comparing the peak voltage signal with a reference signal.

An embodiment of the present invention discloses a switching converter. The switching converter includes a switching circuit, an output feedback circuit, a compensation current generator, a peak voltage generator and a comparison circuit. The switching circuit has a power switch and is configured to convert an input voltage to an output voltage. The output feedback circuit is configured to generate an output voltage feedback signal indicative of the output voltage. The compensation current generator is coupled to the output feedback circuit and is configured to generate a compensation current signal based on the output voltage feedback signal and an output voltage reference signal. The peak voltage generator is configured to generate a peak voltage signal based on the compensation current signal and a current sensing signal indicative of a current flowing through the power switch. The comparison circuit is configured to generate a turning off control signal to control the turning off of the power switch by comparing the peak voltage signal with a reference signal.

An embodiment of the present invention discloses a control method for a switching converter converting an input voltage to an output voltage. The control method includes the following steps. 1) Generating a compensation current signal based on an output voltage feedback signal indicative of the output voltage and an output voltage reference signal. And 2) generating a turning off control signal to control the turning off of a power switch of the switching converter based on the compensation current signal, a current sensing signal indicative of a current flowing through the power switch and a reference signal.

### BRIEF DESCRIPTION OF DRAWINGS

The present invention can be further understood with reference to the following detailed description and the appended drawings, wherein like elements are provided with like reference numerals.

FIG. 1 illustrates a circuit block diagram of a switching converter 100 in accordance with an embodiment of the present invention.

FIG. 2 illustrates a working waveform of the switching converter 100 in accordance with an embodiment of the present invention and a waveform of an output voltage Vout of a prior art switching converter.

FIG. 3 illustrates a circuit block diagram of a switching converter 100A in accordance with another embodiment of the present invention.

FIG. 4 illustrates a circuit block diagram of a switching converter 100B in accordance with yet another embodiment of the present invention.

FIG. 5 illustrates a circuit schematic of a control circuit 11C for the switching converter 100 in accordance with an embodiment of the present invention.

FIG. 6 illustrates a circuit schematic of a control circuit 11D for the switching converter 100 in accordance with another embodiment of the present invention.

FIG. 7 illustrates a working flowchart of a control method 700 for a switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to "one embodiment", "an embodiment", "an example" or "examples" means: certain features, structures, or characteristics are contained in at least one embodiment of the present invention. These "one embodiment", "an embodiment", "an example" and "examples" are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as "connected" or "coupled" to another element, it can be directly connected or coupled to the other element, or there could exist one or more intermediate elements. In contrast, when an element is referred to as "directly connected" or “directly coupled” to another element, there is no intermediate element.

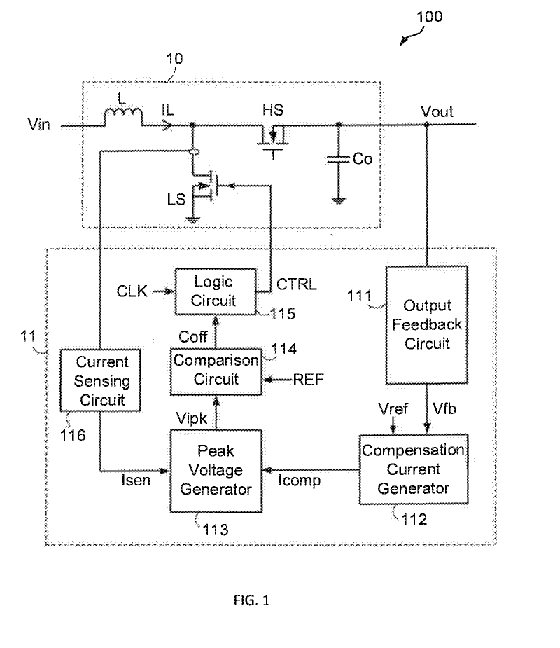

FIG. 1 illustrates a circuit block diagram of a switching converter 100 in accordance with an embodiment of the present invention. As shown in FIG. 1, the switching converter 100 includes a switching circuit 10 and a control circuit 11. The switching circuit 10 employs a boost converter topology, including an inductor L, a high-side power switch HS, a low-side power switch LS and an output capacitor Co. An inductor current IL flows through the inductor L. The switching circuit 10 converts an input voltage Vin to an output voltage Vout to power a load (not shown) by turning on and turning off the power switches HS and LS. Those skilled in the art can understand that the switching circuit 10 may be configured as any suitable DC/DC or AC/DC converter topology, such as synchronous or asynchronous buck, boost, buck-boost, forward, or flyback converters and so on. The power switches HS and LS may be any controllable semiconductor device, such as BJT, JFET, MOSFET, IGBT and so on. In other embodiments, the power switch HS may be replaced by a diode.

The control circuit 11 includes an output feedback circuit 111, a compensation current generator 112, a peak voltage generator 113, a comparison circuit 114 and a logic circuit 115. The control circuit 11 generates a switch control signal CTRL to control the power switch LS. Those skilled in the art can understand that the power switch HS may be controlled by an inverted signal of the switch control signal CTRL. This is not shown in FIG. 1 for simplicity.

The output feedback circuit 111 is coupled to an output terminal of the switching circuit 10 and generates a feedback signal indicative of an output signal (e.g., the output voltage Vout, an output current, or an output power) of the switching circuit 10. In one embodiment, the feedback signal may indicate load transient.

In the example shown in FIG. 1, the output feedback circuit 111 receives the output voltage Vout and generates an output voltage feedback signal Vfb indicative of the output voltage Vout. In one embodiment, when the load becomes heavier, the output voltage feedback signal Vfb decreases; when the load becomes lighter, the output voltage feedback signal Vfb increases.

The compensation current generator 112 is coupled to the output feedback circuit 111 and generates a compensation current signal Icomp based on the load transient. In one embodiment, when the load becomes lighter, the compensation current generator 112 provides the compensation current signal Icomp with a first direction (for example, the compensation current signal Icomp flows out from the compensation current generator 112); when the load becomes heavier, the compensation current generator 112 provides the compensation current signal Icomp with a second direction (for example, the compensation current signal Icomp flows into the compensation current generator 112). In one embodiment, the compensation current signal Icomp is a current signal. In other embodiments, the compensation current signal can also be a voltage signal.

In the example shown in FIG. 1, the compensation current generator 112 generates the compensation current signal Icomp based on the output voltage feedback signal Vfb and an output voltage reference signal Vref. In one embodiment, when the output voltage feedback signal Vfb is higher than the output voltage reference signal Vref , the compensation current signal Icomp has the first direction, and the value of the compensation current signal Icomp increases as the output voltage feedback signal Vfb increases; when the output voltage feedback signal Vfb is lower than the output voltage reference signal Vref, the compensation current signal Icomp has the second direction, and the value of the compensation current signal Icomp increases as the output voltage feedback signal Vfb decreases.

The peak voltage generator 113 receives the compensation current signal Icomp and a current sensing signal Isen indicative of a current flowing through the power switch LS and generates a peak voltage signal Vipk based on the compensation current signal Icomp and the current sensing signal Isen.

In other embodiments, in order to prevent subharmonic oscillations, the peak voltage generator 113 further receives a ramp current signal Islp and generates the peak voltage signal Vipk based on a superimposed signal of the ramp current signal Islp, the compensation current signal Icomp and the current sensing signal Isen.

In the example shown in FIG. 1, the control circuit 11 further includes a current sensing circuit 116 coupled to the power switch LS for generating the current sensing signal Isen. The current sensing circuit 116 may be a resistor sensing circuit, a transformer sensing circuit, a current amplifier sensing circuit and so on. In one embodiment, when the power switch LS is turned on and the power switch HS is turned off, the inductor current IL increases, and the current flowing through the power switch LS is equal to the inductor current IL. Thus, the current sensing signal Isen represents the inductor current IL during the time period when the inductor current IL increases.

The comparison circuit 114 is coupled to the peak voltage generator 113 to receive the peak voltage signal Vipk and generates a turning off control signal Coff to control the turning off of the power switch LS by comparing the peak voltage signal Vipk with a reference signal REF. In one embodiment, when the peak voltage signal Vipk increases to the reference signal REF, the turning off control signal Coff is valid (e.g., high level), and the power switch LS is turned off. In one embodiment, the reference signal REF is related to the output signal (e.g., output voltage Vout) of switching circuit 10.

The logic circuit 115 generates the switch control signal CTRL to control the power switch LS based on a clock signal CLK and the turning off control signal Coff. In one embodiment, when the clock signal CLK arrives, the power switch LS is turned on.

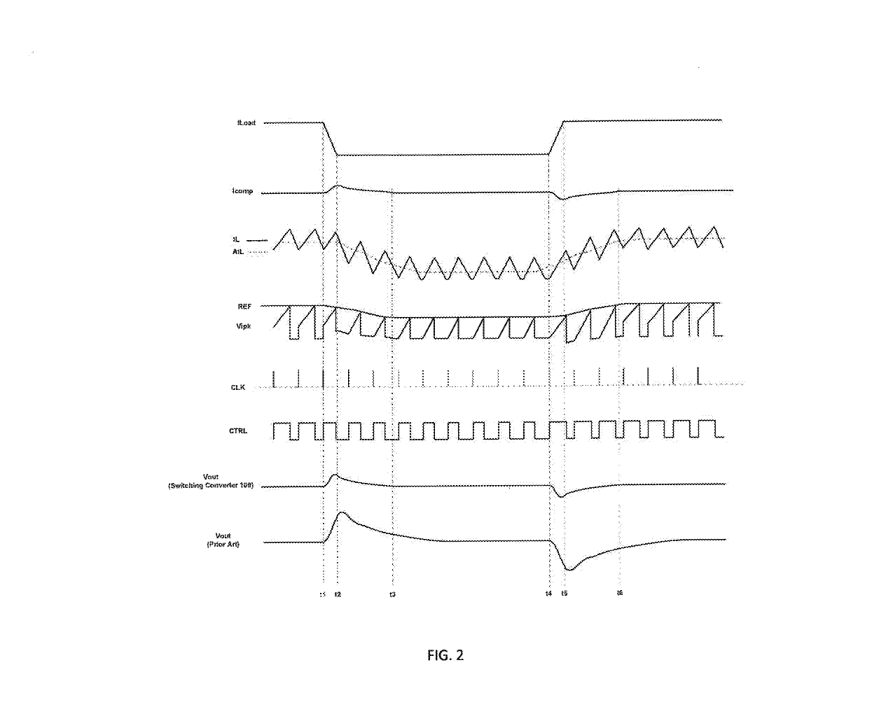

FIG. 2 illustrates a working waveform of the switching converter 100 in accordance with an embodiment of the present invention and a waveform of an output voltage Vout of a prior art switching converter. As shown in FIG. 2, when the clock signal CLK arrives, the switch control signal CTRL changes from low level to high level, the power switch LS is turned on, the inductor current IL increases gradually, and the peak voltage signal Vipk increases with the increase of the inductor current IL. When the peak voltage signal Vipk increases to the reference signal REF, the switch control signal CTRL changes from high level to low level, the power switch LS is turned off, and the inductor current IL decreases gradually.

Before time t1, a load current ILoad keeps unchanged indicating the load remains stable, the compensation current signal Icomp is zero substantially (zero or almost zero), an average inductor current AIL (i.e., the average value of the inductor current IL) remains unchanged, and the output voltage Vout remains stable.

During time period t1~t2, the load becomes lighter (for example, the load current ILoad decreases), the compensation current generator 112 provides the compensation current signal Icomp with the first direction to charge the peak voltage signal Vipk. This allows the peak voltage signal Vipk to increase to the reference signal REF more quickly. Then the duty cycle of the switch control signal CTRL decreases. Thus, the overshoot in the output voltage Vout decreases. Those skilled in the art will understand that the peak voltage signal Vipk is generated based on the compensation current signal Icomp and the current sensing signal Isen. The compensation current signal Icomp with the first direction for charging the peak voltage signal Vipk means that the compensation current signal Icomp with the first direction is used to increase the peak voltage signal Vipk. During the time period when the inductor current IL increases, the current sensing signal Isen increases, and the peak voltage signal Vipk also increases with the increase of the current sensing signal Isen. During this time period, due to the peak voltage signal Vipk further being charged by the compensation current signal Icomp, the increase rate of the peak voltage signal Vipk is accelerated. Those skilled in the art can understand that the duty cycle of the switch control signal CTRL refers to the ratio of the high level duration of the switch control signal CTRL to the switching period.

During time period t2~t3, the compensation current signal Icomp gradually decreases until it recovers to zero substantially, and the output voltage Vout gradually decreases until it recovers to an expected value. The compensation current signal Icomp decreasing gradually allows the control loop of the switching converter 100 sufficient time to adjust, and the switching converter 100 can transition to the next steady state (e.g., time period t3~t4) smoothly.

During time period t3~t4, the switching converter 100 operates in steady state, the compensation current signal Icomp is zero substantially, and the output voltage Vout remains stable.

During time period t4~t5, the load becomes heavier (for example, the load current ILoad increases), the compensation current generator 112 provides the compensation current signal Icomp with the second direction to discharge the peak voltage signal Vipk. This causes the peak voltage signal Vipk to increase to the reference signal REF more slowly. Then the duty cycle of the switch control signal CTRL increases. Thus, the undershoot in the output voltage Vout decreases. Those skilled in the art will understand that the peak voltage signal Vipk is generated based on the compensation current signal Icomp and the current sensing signal Isen. The compensation current signal Icomp with the second direction for discharging the peak voltage signal Vipk means that the compensation current signal Icomp with the second direction is used to decrease the peak voltage signal Vipk. During the time period when the inductor current IL increases, the current sensing signal Isen increases, and the peak voltage signal Vipk also increases with the increase of the current sensing signal Isen. During this time period, due to the peak voltage signal Vipk being discharged by the compensation current signal Icomp, the increase rate of the peak voltage signal Vipk is slowed down.

During time period t5~t6, the compensation current signal Icomp gradually increases until it recovers to zero substantially, and the output voltage Vout gradually increases until it recovers to the expected value. The compensation current signal Icomp increasing gradually allows the control loop of the switching converter 100 sufficient time to adjust, and the switching converter 100 can transition to the next steady state (e.g., after time t6) smoothly.

After time t6, the switching converter 100 operates in steady state, the compensation current signal Icomp is zero substantially, and the output voltage Vout remains stable.

As shown in FIG. 2, compared with the prior art, the switching converter 100 can respond to load transient more quickly, and the overshoot and the undershoot in the output voltage Vout are significantly reduced.

According to the embodiments of the present invention, when the load becomes heavier causing the output voltage Vout to be lower than the expected value, the compensation current generator 112 provides the compensation current signal Icomp with the second direction to discharge the peak voltage signal Vipk, then the duty cycle of the switch control signal CTRL increases, and thus, the output voltage Vout can increase to the expected value more quickly. When the load becomes lighter causing the output voltage Vout to be higher than the expected value, the compensation current generator 112 provides the compensation current signal Icomp with the first direction to charge the peak voltage signal Vipk, then the duty cycle of the switch control signal CTRL decreases, and thus, the output voltage Vout can decrease to the expected value more quickly. This improves the transient response performance of the switching converter 100 and significantly reduces the overshoot and the undershoot in the output voltage Vout caused by load transients. In addition, the peak voltage signal Vipk is generated based on the current sensing signal Isen and has a large variation range. The above embodiments of the present invention generate the peak voltage signal Vipk based on the superimposed signal of the compensation current signal Icomp and the current sensing signal Isen, and thus, the peak voltage signal Vipk has a large fault tolerance range and is less likely to cause interference to the control loop, thereby helping to maintain the stability of the control loop.

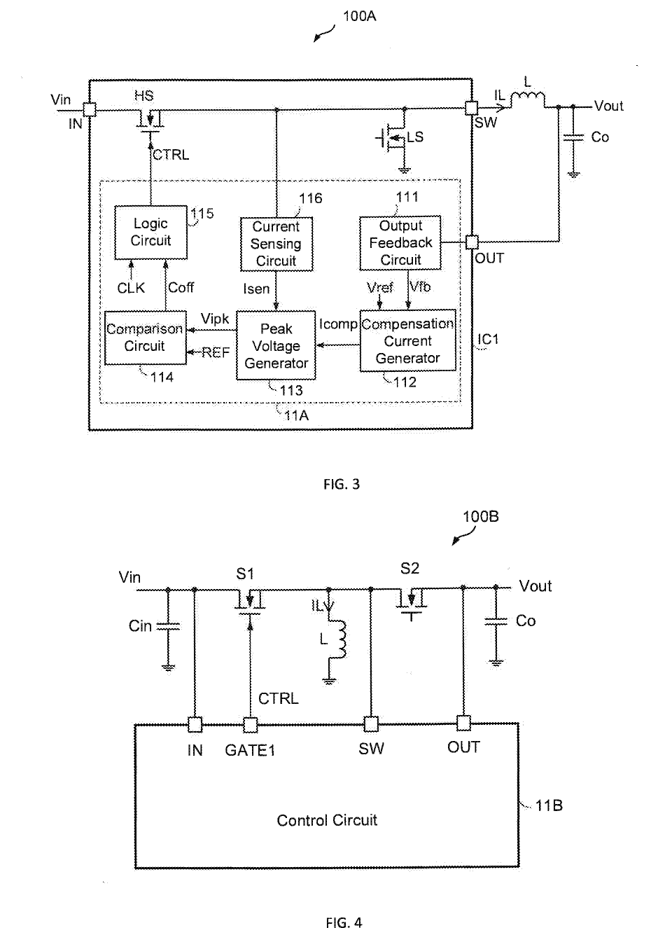

FIG. 3 illustrates a circuit block diagram of a switching converter 100A in accordance with another embodiment of the present invention. The switching converter 100A employs a buck converter topology and includes a power switch HS, a power switch LS, an inductor L and an output capacitor Co, connected as shown in FIG. 3. A control circuit 11A generates a switch control signal CTRL to control the power switch HS. The power switch LS can be controlled by the inverted signal of the switch control signal CTRL. This is not shown in FIG. 3 for simplicity.

In the example shown in FIG. 3, the power switches HS, LS and the control circuit 11A are integrated into a single integrated circuit IC1. The integrated circuit IC1 has a plurality of pins, including an input pin IN configured to receive the input voltage Vin, a switch pin SW coupled to the common connection node of the power switches HS and LS, and an output pin OUT configured to receive the output voltage Vout.

The control circuit 11A includes an output feedback circuit 111, a compensation current generator 112, a peak voltage generator 113, a comparison circuit 114, a logic circuit 115 and a current sensing circuit 116.

The output feedback circuit 111 is coupled to the output pin OUT to receive the output voltage Vout and generates the output voltage feedback signal Vfb indicative of the output voltage Vout.

The compensation current generator 112 is coupled to the output feedback circuit 111 and generates the compensation current signal Icomp based on the output voltage feedback signal Vfb and the output voltage reference signal Vref.

The current sensing circuit 116 is coupled to the switch pin SW and generates the current sensing signal Isen indicative of the current flowing through the power switch HS. In one embodiment, when the power switch HS is turned on and the power switch LS is turned off, the inductor current IL increases, and the current flowing through the power switch HS is equal to the inductor current IL. Thus, the current sensing signal Isen represents the inductor current IL during the time period when the inductor current IL increases.

The peak voltage generator 113 generates the peak voltage signal Vipk based on the compensation current signal Icomp and the current sensing signal Isen.

The comparison circuit 114 compares the peak voltage signal Vipk with the reference signal REF and generates a turning off control signal Coff to control the turning off of the power switch HS.

The logic circuit 115 generates the switch control signal CTRL to control the power switch HS based on the clock signal CLK and the turning off control signal Coff.

The working principle of the control circuit 11A is similar to that of the control circuit 11 shown in FIG. 1 and is omitted here for simplicity.

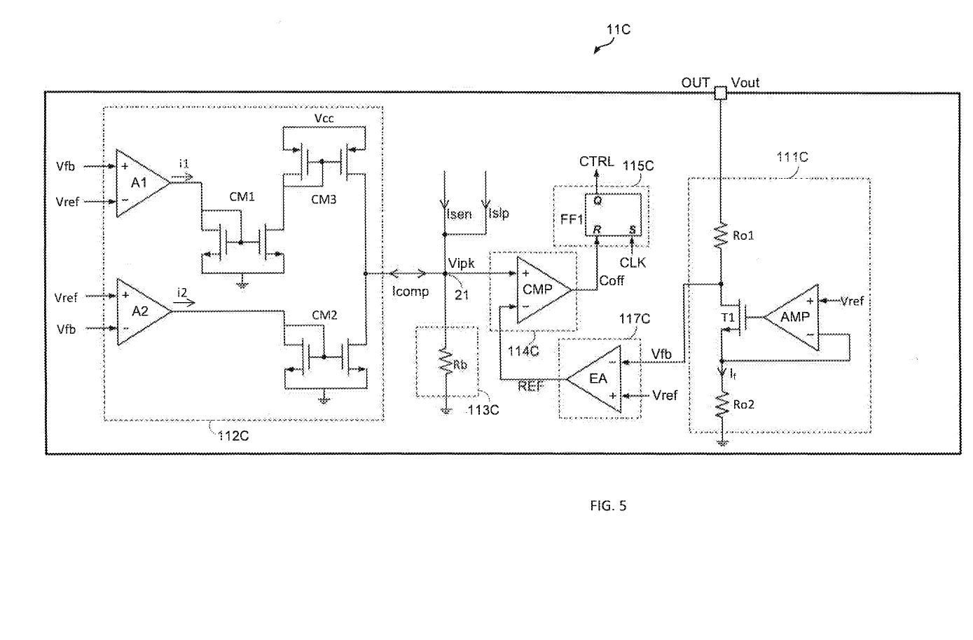

FIG. 4 illustrates a circuit block diagram of a switching converter 100B in accordance with another embodiment of the present invention. The switching converter 100B employs a buck-boost converter topology and includes an input capacitor Cin, a power switch S1, an inductor L, a power switch S2, and an output capacitor Co, connected as shown in FIG. 4.

In the example shown in FIG. 4, the control circuit 11B has a plurality of pins, including an input pin IN configured to receive the input voltage Vin, a driving pin GATE1 for providing the switch control signal CTRL to the power switch S1, a switch pin SW coupled to the common connection node of power switches S1 and S2, and an output pin OUT configured to receive the output voltage Vout. The control circuit 11B generates the switch control signal CTRL to control the power switch S1. The power switch S2 can be controlled by the inverted signal of the switch control signal CTRL. This is not shown in FIG. 4 for simplicity.

The working principle of the control circuit 11B is similar to that of the control circuit 11 shown in FIG. 1 and the control circuit 11A shown in FIG. 3 and thus is omitted here for simplicity.

FIG. 5 illustrates a circuit schematic of a control circuit 11C for the switching converter 100 in accordance with an embodiment of the present invention. The control circuit 11C includes an output pin OUT, an output feedback circuit 111C, a compensation current generator 112C, a peak voltage generator 113C, a comparison circuit 114C, a logic circuit 115C and an error amplifying circuit 117C.

The output pin OUT is configured to receive the output voltage Vout. The output feedback circuit 111C is coupled to the output pin OUT to receive the output voltage Vout and generates the output voltage feedback signal Vfb indicative of the output voltage Vout.

In the example shown in FIG. 5, the output feedback circuit 111C includes a resistor Ro1, a transistor T1, a resistor Ro2 and an operational amplifier AMP. The resistor Ro1 has a first terminal and a second terminal, where the first terminal is coupled to the output pin OUT. The transistor T1 has a first terminal, a second terminal and a control terminal, where the first terminal is coupled to the second terminal of the resistor Ro1. The resistor Ro2 has a first terminal and a second terminal, where the first terminal is coupled to the second terminal of the transistor T1, and the second terminal is coupled to a reference ground. The operational amplifier AMP has a first input terminal, a second input terminal and an output terminal, where the first input terminal receives the output voltage reference signal Vref, the second input terminal is coupled to the common connection node of the transistor T1 and the resistor Ro2, and the output terminal is coupled to the control terminal of the transistor T1. The output feedback circuit 111C uses the operational amplifier AMP to control the current I_{f} flowing through resistors Ro1 and Ro2 to a constant value. I_{f} = Vref / Ro2. Then Vfb = Vout - I_{f} * Ro1 = Vout - Vref * Ro1/Ro2. The output feedback circuit 111C can directly transmit the change in the output voltage Vout to the output voltage feedback signal Vfb (i.e., the change in the output voltage feedback signal Vfb is the same as the change in the output voltage Vout). Therefore, the output voltage feedback signal Vfb can reflect the change in the output voltage Vout in a timely and effective manner.

The compensation current generator 112C generates the compensation current signal Icomp based on the output voltage feedback signal Vfb and the output voltage reference signal Vref. When the output voltage feedback signal Vfb is lower than the output voltage reference signal Vref, the compensation current signal Icomp has the second direction (flowing into the compensation current generator 112C from the node 21); when the output voltage feedback signal Vfb is higher than the output voltage reference signal Vref, the compensation current signal Icomp has the first direction (flowing into the node 21 from the compensation current generator 112C). When the output voltage feedback signal Vfb is higher than the output voltage reference signal Vref, a first current signal i1 is provided; when the output voltage feedback signal Vfb is lower than the output voltage reference signal Vref, a second current signal i2 is provided. The compensation current generator 112C generates the compensation current signal Icomp based on the first current signal i1 and the second current signal i2.

In the example shown in FIG. 5, the compensation current generator 112C includes a first transconductance amplifier A1, a second transconductance amplifier A2, a first current mirror CM1, a second current mirror CM2 and a third current mirror CM3.

The first transconductance amplifier A1 has a first input terminal, a second input terminal and an output terminal. The first input terminal receives the output voltage feedback signal Vfb, and the second input terminal receives the output voltage reference signal Vref. When the output voltage feedback signal Vfb is higher than the output voltage reference signal Vref, the first transconductance amplifier A1 provides the first current signal i1 at the output terminal.

The second transconductance amplifier A2 has a first input terminal, a second input terminal, and an output terminal. The first input terminal receives the output voltage reference signal Vref, and the second input terminal receives the output voltage feedback signal Vfb. When the output voltage feedback signal Vfb is lower than the output voltage reference signal Vref, the second transconductance amplifier A2 provides the second current signal i2 at the output terminal.

The first current mirror CM1 has a first terminal, a second terminal and a ground terminal, where the first terminal is coupled to the output terminal of the first transconductance amplifier A1, and the ground terminal is coupled to the reference ground.

The second current mirror CM2 has a first terminal, a second terminal and a ground terminal, where the first terminal is coupled to the output terminal of the second transconductance amplifier A2, and the ground terminal is coupled to the reference ground.

The third current mirror CM3 has a first terminal, a second terminal and a power supply terminal. The first terminal is coupled to the second terminal of the first current mirror CM1, the second terminal is coupled to the second terminal of the second current mirror CM2, and the power supply terminal is coupled to a supply voltage Vcc. The second terminal of the second current mirror CM2 and the second terminal of the third current mirror CM3 are coupled together to provide the compensation current signal Icomp.

The peak voltage generator 113C includes a resistor Rb. The compensation current signal Icomp, the current sensing signal Isen and the ramp current signal Islp flow through the resistor Rb and the peak voltage signal Vipk is generated at node 21. In another embodiment, the peak voltage generator 113C may include a transimpedance amplifier. In one embodiment, the compensation current signal is a volage signal, and the peak voltage generator 113C further includes an adder. The resistor Rb converts the current sensing signal Isen and the ramp current signal Islp to a converted voltage signal. The adder provides the peak voltage signal Vipk by adding the compensation current signal with the converted voltage signal.

The error amplifying circuit 117C has a first input terminal, a second input terminal and an output terminal, where the first input terminal receives the output voltage feedback signal Vfb, and the second input terminal receives the output voltage reference signal Vref. Based on the difference between the output voltage reference signal Vref and the output voltage feedback signal Vfb, the error amplifying circuit 117C generates the reference signal REF at the output terminal. In one embodiment, the error amplifying circuit 117C includes an error amplifier EA.

The comparison circuit 114C has a first input terminal, a second input terminal and an output terminal, where the first input terminal receives the peak voltage signal Vipk, and the second input terminal receives the reference signal REF. The comparison circuit 114C compares the peak voltage signal Vipk with the reference signal REF and generates the turning off control signal Coff at the output terminal. In one embodiment, the comparison circuit 114C includes a comparator CMP.

The logic circuit 115C includes a RS flip-flop FF1. The RS flip-flop FF1 has a set terminal S, a reset terminal R and an output terminal Q. The set terminal S receives the clock signal CLK, the reset terminal R receives the turning off control signal Coff, and the output terminal Q provides the switch control signal CTRL.

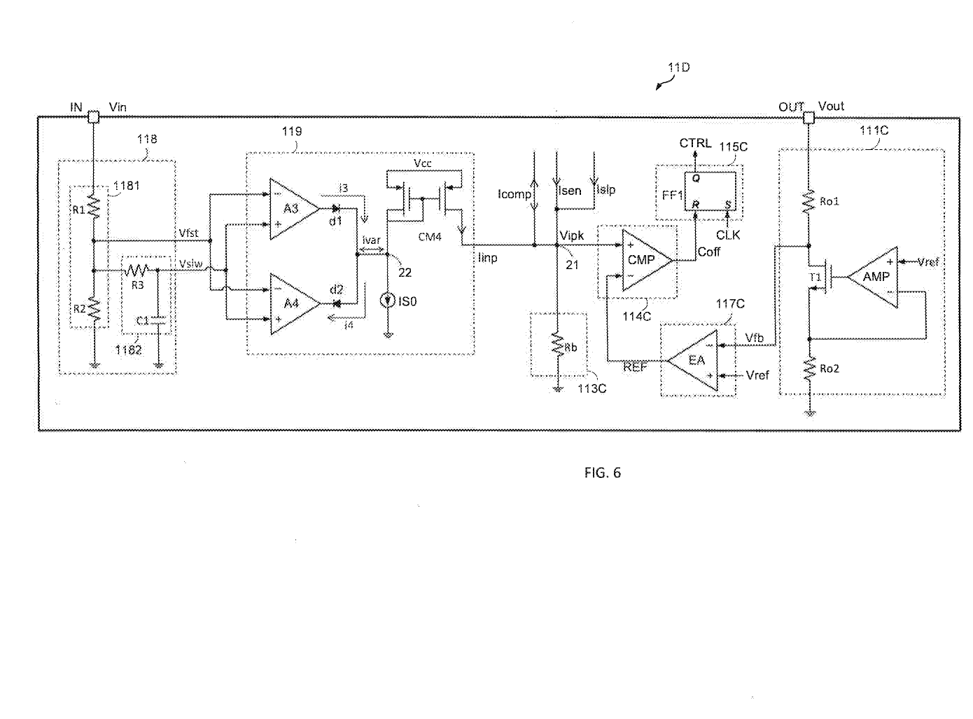

FIG. 6 illustrates a circuit schematic of a control circuit 11D for the switching converter 100 in accordance with another embodiment of the present invention. Different from the control circuit 11C shown in FIG. 5, the control circuit 11D further includes an input pin IN, an input detection circuit 118 and an input compensation circuit 119. The input pin IN is configured to receive the input voltage Vin. The input detection circuit 118 is coupled to the input pin IN to detect the input voltage Vin and generates at least one signal indicative of a change in the input voltage Vin. The input compensation circuit 119 is coupled to the input detection circuit 118 and generates an input compensation current signal linp varying with the change in the input voltage Vin.

The input compensation current signal linp, the compensation current signal Icomp, the current sensing signal Isen and the ramp current signal Islp flow through the resistor Rb and the peak voltage signal Vipk is generated at node 21. In one embodiment, when the input voltage Vin increases, the input compensation current signal linp increases, thereby increasing the peak voltage signal Vipk; when the input voltage Vin decreases, the input compensation current signal linp decreases, thereby decreasing the peak voltage signal Vipk.

In the example shown in FIG. 6, the input detection circuit 118 includes a voltage dividing circuit 1181 and a low-pass filter 1182. The voltage dividing circuit 1181 includes resistors R1 and R2 and generates a first voltage signal Vfst indicative of the input voltage Vin. The low-pass filter 1182 includes resistor R3 and capacitor C1 and generates a second voltage signal Vslw by low-pass filtering the input voltage Vin or a divided voltage of the input voltage Vin (for example, the first voltage signal Vfst).

The input compensation circuit 119 includes a third transconductance amplifier A3, a fourth transconductance amplifier A4, diodes d1 and d2, a current source IS0 and a fourth current mirror CM4.

The third transconductance amplifier A3 has a first input terminal, a second input terminal and an output terminal, where the first input terminal receives the first voltage signal Vfst, and the second input terminal receives the second voltage signal Vslw. When the first voltage signal Vfst is lower than the second voltage signal Vslw, the third transconductance amplifier A3 provides a third current i3.

The fourth transconductance amplifier A4 has a first input terminal, a second input terminal and an output terminal, where the first input terminal receives the first voltage signal Vfst, and the second input terminal receives the second voltage signal Vslw. When the first voltage signal Vfst is higher than the second voltage signal Vslw, the fourth transconductance amplifier A4 provides a fourth current i4. In one embodiment, the third current i3and the fourth current i4have different directions. For example, the third current i3 frows from the common connection node of the transconductance amplifier A3 and A4 to the node 22. The fourth current i4 frows from the node 22 to the common connection node of the transconductance amplifier A3 and A4.

The output terminal of the third transconductance amplifier A3 and the output terminal of the fourth transconductance amplifier A4 are coupled together to provide a current ivar. When the first voltage signal Vfst is lower than the second voltage signal Vslw, the current ivar is equal to the third current i3 and flows from the third transconductance amplifier A3 to the node 22; when the first voltage signal Vfst is higher than the second voltage signal Vslw, the current ivar is equal to the fourth current i4 and flows from the node 22 into the fourth transconductance amplifier A4. When the switching converter 100 is in steady state, the first voltage signal Vfst is equal to the second voltage signal Vslw, and the current ivar is zero substantially. Those skilled in the art will understand that in the example shown in FIG. 6, diodes d1 and d2 are used to help understand the direction of the current ivar. In practical applications, diodes d1 and d2 can be omitted.

The current source IS0 is coupled between the node 22 and the reference ground. The fourth current mirror CM4 has a power supply terminal, a first terminal and a second terminal, where the power supply terminal is configured to receive the supply voltage Vcc, and the first terminal is coupled to the node 22. The fourth current mirror CM4 provides the input compensation current signal Iinp at the second terminal based on the current ivar and a current provided by the current source IS0.

According to the embodiment shown in FIG. 6, when the input voltage Vin changes suddenly, the input compensation circuit 119 generates the input compensation current signal linp varying with the change in the input voltage Vin to change the peak voltage signal Vipk, thereby changing the duty cycle of the switch control signal CTRL accordingly. As a result, the switching converter 100 can quickly adapt to the transient in the input voltage Vin and reduce the overshoot or the undershoot in the output voltage Vout.

Those skilled in the art will understand that the above embodiments are used for illustrative purposes, not for limiting the present invention. Other suitable circuits capable of achieving the same or similar functions also satisfy the spirit and scope of the present invention. For example, the compensation current generator 112 can also be implemented like the input compensation circuit 119 by using two transconductance amplifiers (transconductance amplifiers A3 and A4 in FIG. 6).

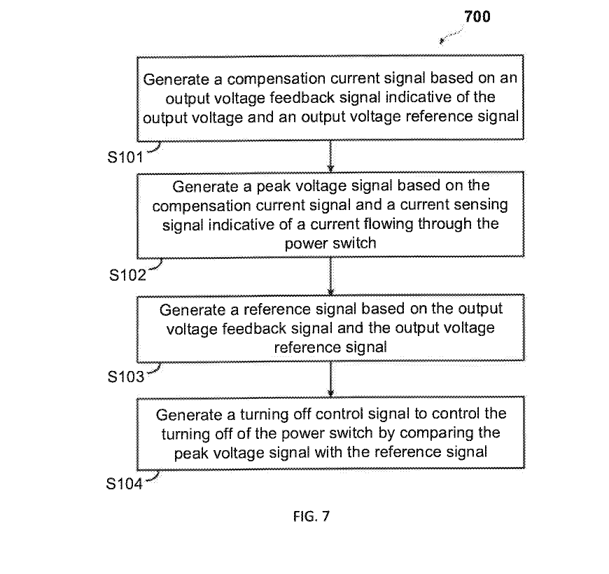

FIG. 7 illustrates a working flowchart of a control method 700 for a switching converter in accordance with an embodiment of the present invention. The switching converter has a power switch and converts an input voltage to an output voltage based on the turning on and the turning off of the power switch. The control method 700 includes steps S101~S104.

At step S101, a compensation current signal is generated based on an output voltage reference signal and an output voltage feedback signal indicative of the output voltage. Those skilled in the art can understand that the compensation current signal in the above embodiments of the present invention can be a current signal, it can also be a voltage signal.

At step S102, a peak voltage signal is generated based on the compensation current signal and a current sensing signal indicative of a current flowing through the power switch.

At step S103, a reference signal is generated based on the output voltage reference signal and the output voltage feedback signal.

At step S104, a turning off control signal is generated to control the turning off of the power switch by comparing the peak voltage signal with the reference signal.

In one embodiment, when the output voltage feedback signal is higher than the output voltage reference signal, the compensation current signal is used to charge the peak voltage signal; when the output voltage feedback signal is lower than the output voltage reference signal, the compensation current signal is used to discharge the peak voltage signal.

In the above embodiments, the compensation current signal is superimposed on the current sensing signal to generate the peak voltage signal. In other embodiment, the compensation current signal can also be added to or subtracted from the reference signal.

Those skilled in the art can understand that the high level/low level of control signal is related to the type of the power switch. For example, if the power switch is N-type MOSFET, when the control signal is high level, the power switch is turned on; when the control signal is low level, the power switch is turned off. If the power switch is P-type MOSFET, when the control signal is high level, the power switch is turned off; when the control signal is low level, the power switch is turned on. The high level/low level of the control signals shown in the above embodiments are used for illustrative purposes, not used for limiting the present invention.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order in accordance with such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a switching converter converting an input voltage to an output voltage, the control circuit comprising:
a compensation current generator configured to generate a compensation current signal based on an output voltage feedback signal indicative of the output voltage and an output voltage reference signal;
a peak voltage generator configured to generate a peak voltage signal based on the compensation current signal and a current sensing signal indicative of a current flowing through a power switch of the switching converter; and
a comparison circuit configured to generate a turning off control signal to control the turning off of the power switch by comparing the peak voltage signal with a reference signal.

2. The control circuit of claim 1, wherein:
when the output voltage feedback signal is higher than the output voltage reference signal, the compensation current signal is used to charge the peak voltage signal; and wherein
when the output voltage feedback signal is lower than the output voltage reference signal, the compensation current signal is used to discharge the peak voltage signal.

3. The control circuit of claim 1, wherein:
when the output voltage feedback signal is higher than the output voltage reference signal, the compensation current generator is configured to provide a first current signal; and wherein
when the output voltage feedback signal is lower than the output voltage reference signal, the compensation current generator is configured to provide a second current signal; and wherein
the compensation current generator is configured to generate the compensation current signal based on the first current signal and the second current signal.

4. The control circuit of claim 3, wherein the compensation current generator comprises:
a first transconductance amplifier having a first input terminal, a second input terminal and an output terminal, wherein the first input terminal is configured to receive the output voltage feedback signal, and the second input terminal is configured to receive the output voltage reference signal;
a first current mirror having a first terminal and a second terminal, wherein the first terminal is coupled to the output terminal of the first transconductance amplifier;
a second transconductance amplifier having a first input terminal, a second input terminal and an output terminal, wherein the first input terminal is configured to receive the output voltage reference signal, and the second input terminal is configured to receive the output voltage feedback signal;
a second current mirror having a first terminal and a second terminal, wherein the first terminal is coupled to the output terminal of the second transconductance amplifier; and
a third current mirror having a first terminal and a second terminal, wherein the first terminal of the third current mirror is coupled to the second terminal of the first current mirror, and the second terminal of the third current mirror is coupled to the second terminal of the second current mirror to provide the compensation current signal together.

5. The control circuit of claim 1, wherein the switching converter further comprises an output feedback circuit, wherein the output feedback circuit comprises:
a first resistor having a first terminal and a second terminal, wherein the first terminal is configured to receive the output voltage;
a transistor having a first terminal, a second terminal and a control terminal, wherein the first terminal is coupled to the second terminal of the first resistor to provide the output voltage feedback signal;
a second resistor having a first terminal and a second terminal, wherein the first terminal is coupled to the second terminal of the transistor, and the second terminal is coupled to a reference ground; and
an operational amplifier having a first input terminal, a second input terminal and an output terminal, wherein the first input terminal is configured to receive the output voltage reference signal, the second input terminal is coupled to a common connection node of the transistor and the second resistor, and the output terminal is coupled to the control terminal of the transistor.

6. The control circuit of claim 1, further comprising:
an input compensation circuit configured to generate an input compensation current signal varying with a change in the input voltage; wherein
the peak voltage generator is configured to convert a superimposed signal of the input compensation current signal, the compensation current signal and the current sensing signal to the peak voltage signal.

7. The control circuit of claim 6, wherein:
when the input voltage increases, the input compensation current signal increases; and wherein
when the input voltage decreases, the input compensation current signal decreases.

8. The control circuit of claim 6, wherein the switching converter further comprises:
an input detection circuit configured to generate a first voltage signal indicative of the input voltage and configured to generate a second voltage signal by low-pass filtering the input voltage or a divided voltage of the input voltage; wherein
the input compensation circuit is configured to generate the input compensation current signal based on the first voltage signal and the second voltage signal.

9. A switching converter, comprising:
a switching circuit having a power switch and configured to convert an input voltage to an output voltage;
an output feedback circuit configured to generate an output voltage feedback signal indicative of the output voltage;
a compensation current generator coupled to the output feedback circuit and configured to generate a compensation current signal based on the output voltage feedback signal and an output voltage reference signal;
a peak voltage generator configured to generate a peak voltage signal based on the compensation current signal and a current sensing signal indicative of a current flowing through the power switch; and
a comparison circuit configured to generate a turning off control signal to control the turning off of the power switch by comparing the peak voltage signal with a reference signal.

10. The switching converter of claim 9, wherein:
when the output voltage feedback signal is higher than the output voltage reference signal, the compensation current signal is used to charge the peak voltage signal; and wherein
when the output voltage feedback signal is lower than the output voltage reference signal, the compensation current signal is used to discharge the peak voltage signal.

11. The switching converter of claim 9, wherein:
when the output voltage feedback signal is higher than the output voltage reference signal, the compensation current generator is configured to provide a first current signal; and wherein
when the output voltage feedback signal is lower than the output voltage reference signal, the compensation current generator is configured to provide a second current signal; and wherein
the compensation current generator is configured to generate the compensation current signal based on the first current signal and the second current signal.

12. The switching converter of claim 11, wherein the compensation current generator comprises:
a first transconductance amplifier having a first input terminal, a second input terminal and an output terminal, wherein the first input terminal is configured to receive the output voltage feedback signal, and the second input terminal is configured to receive the output voltage reference signal;
a first current mirror having a first terminal and a second terminal, wherein the first terminal is coupled to the output terminal of the first transconductance amplifier;
a second transconductance amplifier having a first input terminal, a second input terminal and an output terminal, wherein the first input terminal is configured to receive the output voltage reference signal, and the second input terminal is configured to receive the output voltage feedback signal;
a second current mirror having a first terminal and a second terminal, wherein the first terminal is coupled to the output terminal of the second transconductance amplifier; and
a third current mirror having a first terminal and a second terminal, wherein the first terminal of the third current mirror is coupled to the second terminal of the first current mirror, and the second terminal of the third current mirror is coupled to the second terminal of the second current mirror to provide the compensation current signal together.

13. The switching converter of claim 9, wherein the output feedback circuit comprises:
a first resistor having a first terminal and a second terminal, wherein the first terminal is configured to receive the output voltage;
a transistor having a first terminal, a second terminal and a control terminal, wherein the first terminal is coupled to the second terminal of the first resistor to provide the output voltage feedback signal;
a second resistor having a first terminal and a second terminal, wherein the first terminal is coupled to the second terminal of the transistor, and the second terminal is coupled to a reference ground; and
an operational amplifier having a first input terminal, a second input terminal and an output terminal, wherein the first input terminal is configured to receive the output voltage reference signal, the second input terminal is coupled to a common connection node of the transistor and the second resistor, and the output terminal is coupled to the control terminal of the transistor.

14. The switching converter of claim 9, further comprising:
an input compensation circuit configured to generate an input compensation current signal varying with a change in the input voltage; wherein
the peak voltage generator is configured to convert a superimposed signal of the input compensation current signal, the compensation current signal and the current sensing signal to the peak voltage signal.

15. The switching converter of claim 14, wherein:
when the input voltage increases, the input compensation current signal increases; and wherein
when the input voltage decreases, the input compensation current signal decreases.

16. The switching converter of claim 14, further comprising:
an input detection circuit configured to generate a first voltage signal indicative of the input voltage and configured to generate a second voltage signal by low-pass filtering the input voltage or a divided voltage of the input voltage; wherein
the input compensation circuit is configured to generate the input compensation current signal based on the first voltage signal and the second voltage signal.

17. The switching converter of claim 9, wherein the switching circuit comprises a buck converter, a boost converter or a buck-boost converter.

18. A control method for a switching converter converting an input voltage to an output voltage, the control method comprising:
generating a compensation current signal based on an output voltage feedback signal indicative of the output voltage and an output voltage reference signal; and
generating a turning off control signal to control the turning off of a power switch of the switching converter based on the compensation current signal, a current sensing signal indicative of a current flowing through the power switch and a reference signal.

19. The control method of claim 18, further comprising:
generating a peak voltage signal based on the compensation current signal and the current sensing signal; and
generating a reference signal based on the output voltage feedback signal and the output voltage reference signal; wherein
the turning off control signal is generated by comparing the peak voltage signal and the reference signal.

20. The control method of claim 19, wherein:
when the output voltage feedback signal is higher than the output voltage reference signal, the compensation current signal is used to charge the peak voltage signal; and wherein
when the output voltage feedback signal is lower than the output voltage reference signal, the compensation current signal is used to discharge the peak voltage signal.
